(19) United States
(12) Patent Application Publication
(10) Pub. No.: US 2006/0228025 A1
(43) Pub. Date: Oct. 12, 2006

(54) Portable electronic device having a pattern identification system

(75) Inventors: Kun-Lang Yu, Keelung (TW); Ching-Fuh Lin, Taipei Hsien (TW); Andy Cheng, Taipei (TW)

Correspondence Address: BIRCH STEWART KOLASCH & BIRCH, PO BOX 747, FALLS CHURCH, VA, 22040-0747, US

(73) Assignee: Top Digital Co., Ltd.

(21) Appl. No.: 11/099,618

(22) Filed: Apr. 6, 2005

(51) Int. Cl. G06K 9/00

(52) U.S. Cl. 382/181

(57) ABSTRACT

A portable electronic device having a pattern identification system includes a substrate, an illumination device, a video camera unit (containing a controllable camera lens), a controller, a programmable identification element and a display unit. The substrate is electrically connected to the illumination device, the video camera unit, the controller, the programmable identification element and the display unit. The illumination device initially projects light on a sample pattern. The controller controls the video camera to magnify an image sufficient for identification at the predetermined position of the sample pattern so as to allow capturing an identifiable image of difference with respect to a programmed feature. The video camera unit captures the identifiable image of the predetermined position of the sample pattern and sends it to the programmable identification element for identifying the sample pattern. The display unit displays an identified result of the sample pattern.

### BACKGROUND OF THE INVENTION

1. Field of the Invention

The present invention relates to a portable electronic device having a pattern identification system. More particularly, the present invention relates to the portable electronic device employing the pattern identification system for processing and identifying an image of a pattern or a security mark to prevent from fraud.

2. Description of the Related Art

Currently, the technologies for computer color printing has been continuously progressed that encourages to widely spread forging and copies. Counterfeits of identification, valuable paper and currency can easily conduct vision of ordinary people to confusion and failure in recognition since the forging and copies of various patterns cannot be identified (or checked) by visual measurements. In addition to failure in recognition, eyes of identifiers may be slow down in recognition and thus cannot speed up recognition with thousands of articles. Hence, there is a need for a pattern identification system or device in recognizing the counterfeits of identification, valuable paper and currency.

In general, conventional identification system such as anti-counterfeit machines for recognizing counterfeit money has several drawbacks of overlarge and overweight that necessitates a large installation space and suitable for installation in particular places such as banks, department stores or public places etc. Adversely, a big identification system unavoidably becomes disadvantages and is unsuitable for small stores or individual persons where installations are limited. Especially, ordinary peoples who require identifying banknotes in anytime and anywhere dislike an overweight identification system.

With regard to pattern identification, iridescent shifting ink or fluorescence filament can be easily counterfeited or forged, and is uneasy to be identified in visual identification. Using a counterfeit detection device, there is a possibility of failure in recognition of iridescent shifting ink and fluorescence filament which may be faded out and abraded resulting from a long-term use. Even an ultraviolet lamp, which is designated for identifying fluorescence filament and advantageously portable, a successful rate of ultraviolet identification is low. However, on the one hand few people are willing to bring even a pocket-sized ultraviolet lamp, on the other hand the ultraviolet lamp has a low successful rate in recognition since fluorescence filament is easily counterfeited. Accordingly, the ultraviolet lamp is unpopular in the market.

In fact, banknotes, valuable papers, public documents and certificates have common features of printing, spectra and fibers that are adequate to be identified features for recognition. Although the technologies for computer color printing and copy have been continuously progressed, common features of printing, spectra and fibers cannot be forged and copied, namely, the common features between true and false are distinguishable. Accordingly, the features of general public documents and certificates are adequate to be identified without providing with security features. Credit cards, banknotes and valuable papers with security features still have common features of printing, spectra and fibers are adequate to be identified.

Simply, there is only a need for identifying features of printing, spectra and fibers for accurately recognizing forges and copies, or identifying a security feature printed on a product, a wrapping paper and a package etc.

Taiwanese Patent Publication No. 501835, published on Sep. 1, 2002, discloses a word-recognition cellular phone. The cellular phone includes a controller, a scanner unit, a word-recognition unit, a screen and a storage unit. The scanner unit is arranged on a face panel and electrically connected with to the controller. The word-recognition unit is provided in the cellular phone and electrically connected with to the controller and the scanner unit. The screen is also arranged on the face panel and electrically connected with to the controller and the word-recognition unit. The storage unit is also provided in the cellular phone and electrically connected with to the controller and the word-recognition unit.

Although the word-recognition cellular phone disclosed in No. 501835 is designated for a first core function for becoming a portable device and a second core function for providing an additional function, the cellular phone is only provided with a second core function for word recognition. However, portable devices such as cellular phones can be redesigned for incorporating an additional function such as counterfeit detection in addition to the portable function. Accordingly, ordinary peoples can use the cellular phone for identifying counterfeit detection of currencies in daily lives.

However, the cellular phone has been widely used and can be used as a portable electronic device providing with an identification function for an identifiable image or a security pattern of difference.

The present invention intends to provide a portable electronic device incorporating with an identification element and a video camera unit which are used to identify features of printing, spectra and fibers of an image captured from a predetermined point of a pattern in such a way to mitigate and overcome the above problem.

### SUMMARY OF THE INVENTION

The primary objective of this invention is to provide a portable electronic device having a pattern identification system to identify features of printing, spectra and fibers of an image, captured from a predetermined point of a sample pattern, by sufficiently magnifying it to obtain an identifiable image of difference with respect to a programmed feature. Thereby, the portable electronic device can provide with an additional function of counterfeit detection.

The secondary objective of this invention is to provide a portable electronic device incorporating with an identification element and a video camera unit. Thereby, the portable electronic device is convenient for counterfeit detection.

The portable electronic device having the pattern identification system in accordance with the present invention includes a substrate, an illumination device, a video camera unit (containing a controllable camera lens), a controller, a programmable identification element and a display unit. The substrate is electrically connected to the illumination device, the video camera unit, the controller, the programmable identification element and the display unit. The illumination device initially projects light on a sample or security pattern. The controller controls the video camera to magnify an image sufficient for identification at the predetermined position of the sample pattern so as to allow capturing an identifiable image of difference with respect to a programmed feature. The video camera unit captures the identifiable image of the predetermined position of the sample pattern and sends it to the programmable identification element for identifying the sample pattern. The display unit displays an identified result of the sample pattern.

In a separate aspect of the present invention is that the illumination device projects a particular wavelength and brightness of light on the sample pattern so as to allow the video camera unit capturing the image of the sample pattern.

In a further separate aspect of the present invention is that the video camera unit consists of a camera device and a telescopic, fixing device mounted on a periphery of the camera device so as to adjust and fix a relative distance between the camera device and the sample pattern.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front plan view of a portable electronic device, such as a cellular phone, having a pattern identification system in accordance with a first embodiment of the present invention;

FIG. 2 is a rear plan view of the portable electronic device, such as a cellular phone, having the pattern identification system in accordance with the first embodiment of the present invention;

FIG. 3 is a side elevational view of the portable electronic device, such as a cellular phone, having the pattern identification system in accordance with the first embodiment of the present invention;

FIG. 4 is a side elevational view of the portable electronic device, such as a cellular phone, having the pattern identification system in accordance with the first embodiment of the present invention applied to a sample pattern;

FIG. 5 is a flow chart of the portable electronic device having the pattern identification system in accordance with the first embodiment of the present invention;

FIG. 6 is a rear plan view of the portable electronic device, such as a personal digital assistant (PDA), having the pattern identification system in accordance with a second embodiment of the present invention;

FIG. 7 is a side elevational view of the portable electronic device, such as a personal digital assistant (PDA), having the pattern identification system in accordance with the second embodiment of the present invention in extending operation;

FIG. 8 is a rear plan view of the portable electronic device, such as a digital camera, having the pattern identification system in accordance with a third embodiment of the present invention; and

FIG. 9 is a side elevational view of the portable electronic device, such as a digital camera, having the pattern identification system in accordance with the third embodiment of the present invention in extending operation.

### DETAILED DESCRIPTION OF THE INVENTION

The term “portable electronic device,” defined in the present invention, includes a cellular phone, a beeper, a personal digital assistant (PDA), an electronic translator, a digital camera and other portable consumer electronics etc. The pattern identification system in accordance with the present invention may be used with a variety of the portable electronic devices. A cellular phone, a personal digital assistant (PDA) and a digital camera incorporating with the pattern identification systems are exemplified in embodiments of the present invention. It should be appreciated that combinations and variations of the pattern identification system with the other portable electronic devices in accordance with the present invention may be implemented and are within the scope of the present invention.

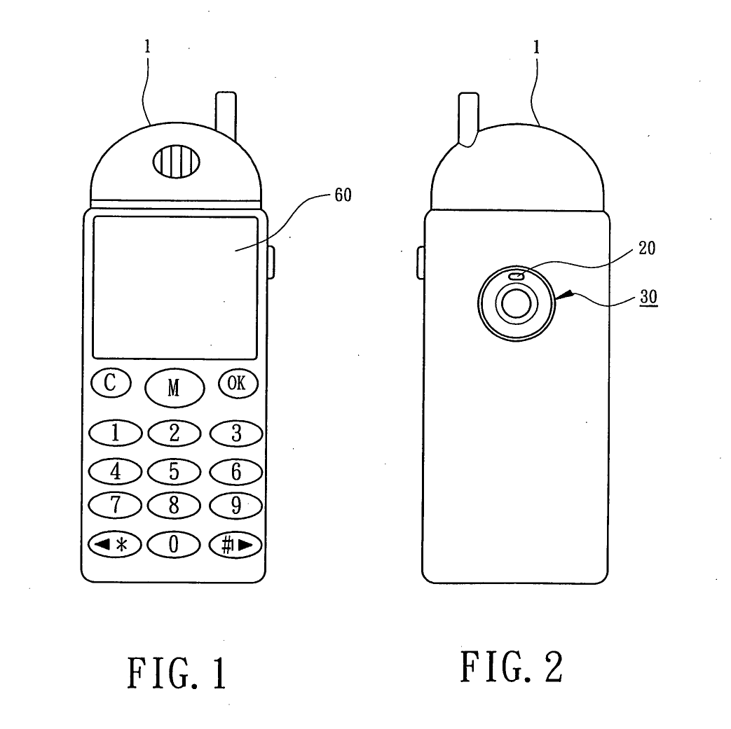

Referring initially to FIGS. 1 through 3, a cellular phone 1 having the pattern identification system in accordance with the first embodiment of the present invention includes a substrate 10, an illumination device 20, a video camera unit 30, a controller 40, a programmable identification element 50 and a display unit 60. The substrate 10 is suitable for communication appliances such as cellular phones which provide with a fundamental function for communication. The substrate 10 is electrically connected to the illumination device 20, the video camera unit 30, the controller 40, the programmable identification element 50 and the display unit 60 so that the cellular phone 1 is capable of operating counterfeit detection.

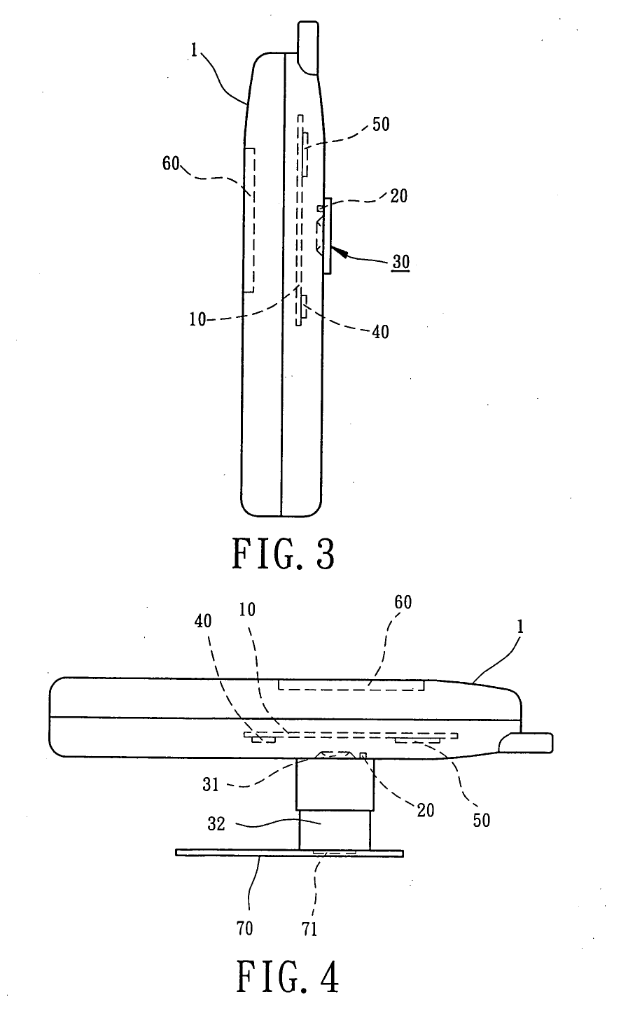

Referring to FIGS. 3 and 4, the illumination device 20, the video camera unit 30 and the display unit 60 are disposed at predetermined positions on a casing of the cellular phone 1. Incorporated into the substrate 10 are the controller 40 and the programmable identification element 50 so that the substrate 10 can provide with an additional function for operating counterfeit detection.

Referring again to FIGS. 2 and 4, the illumination device 20 can be selected from a group consisting of a light emitting diode, a laser illuminator or other particular light wavelength sources which can emit or generate light of red, green, blue, infrared, ultraviolet etc. The controller 40 controls the illumination device 20 and the video camera unit 30 for operating at the same time. The illumination device 20 can selectively projects a particular wavelength and brightness of light according to features of the sample or security patterns and selects a predetermined position of the sample pattern for capturing an image.

Still referring to FIGS. 2 and 4, the video camera unit 30 includes a camera device 31 and a telescopic, fixing device 32. Preferably, the camera device 31 includes a magnifying camera lens having a predetermined magnification rate which is adapted to magnify the sample pattern with a predetermined magnification rate. The camera device 31 then captures a reflecting image of the sample pattern. The telescopic, fixing device 32 is extendable and mounted on a periphery of the camera device so as to adjust and fix a relative distance between the camera device 31 and the sample pattern. Alternatively, the telescopic, fixing device 32, in an embodiment, includes two separate members of a telescopic device and a fixing device. In addition, the telescopic, fixing device 32 can prevent the sample pattern from interfering with external light. Preferably, the telescopic, fixing device 32 can be a retractable device which can be retracted into the casing of the cellular phone 1. Alternatively, the telescopic, fixing device 32 can be a detachable tube which can be detached from the casing of the cellular phone 1. After identifying, the telescopic, fixing device 32 can be retracted into or detached from the casing of the cellular phone 1 which can return to permit making a phone call.

Referring again to FIG. 2, the illumination device 20 is arranged on a peripheral area or a periphery of the camera device 31 of the video camera unit 30.

Referring again to FIGS. 3 and 4, the controller 40 is selected from a group consisting of a logically controllable circuit, a controller chip and a central processing unit (CPU). The controller 40 is electrically connected with the illumination device 20, the video camera unit 30, the programmable identification element 50 and the display unit 60 so that the cellular phone 1 is capable of processing identification for the sample pattern.

Still referring to FIGS. 3 and 4, the programmable identification element 50 is an identification logical circuit or an identification IC programmed by a computer software. For example, valuable papers issued by one country may include a particular common feature necessitating first identification logic, and valuable papers issued by another country may include another particular common feature necessitating second identification logic. Also, currencies issued by one country may include a particular common feature necessitating first identification logic, and currencies issued by another country may include another particular common feature necessitating a second identification logic. Accordingly, the programmable identification element 50 of the cellular phone 1 is changeable or the cellular phone 1 includes a socket (not shown) for changing the programmable identification element 50 according to the features of the sample pattern.

The display unit 60 may display an identified result outputted from the programmable identification element 50 during identifying operation. Preferably, the display unit 60 may be selected from a group consisting of Light Emitting Diodes (LED), Liquid Crystal Displays (LCD) or any other display contrivances.

Referring to FIG. 4, the cellular phone 1 is applied to a sample pattern (i.e. credit card) 70 for logical identification. The sample pattern 70 includes a security mark 71 on its surface for permitting logical identification. The telescopic, fixing device 32 can be extended a predetermined distance, and an end of the telescopic, fixing device 32 is attached to the security mark 71 of the sample pattern 70. The security mark 71 is preferably printed on, adhered or attached to the wrapping paper or package, and adhesive or any other contrivance may thus be used.

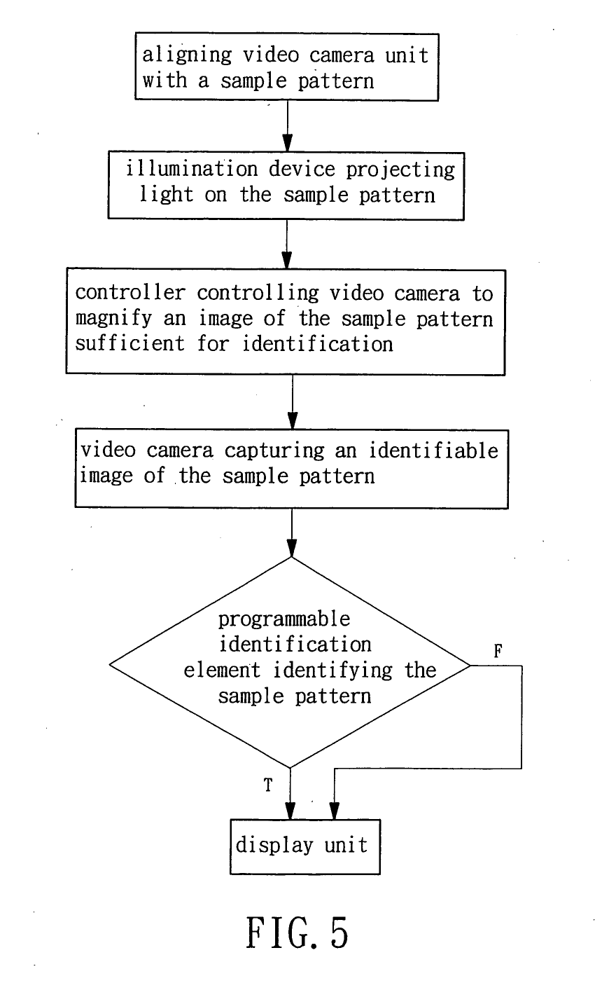

Turning now to FIG. 5, in identifying operation, the portable electronic device (i.e. cellular phone 1) in accordance with the present invention is initially aligned with the security mark 71 of the sample pattern 70. The illumination device 20 projects a light beam on the security mark 71.

Referring again to FIGS. 4 and 5, the camera device 31 of the video camera unit 30 can subsequently magnify an image of the sample pattern 70 with a predetermined magnifying times sufficient for identification, and capture an image of the security mark 71 of the sample pattern 70. The magnifying times processed by the video camera unit 30 are able to capture an identifiable image of difference with respect to a programmed feature.

Referring again to FIGS. 4 and 5, the controller 40 subsequently connects to the programmable identification element 50 and sends the identifiable image thereto for identifying the security mark 71 of the sample pattern 70. The features of the security mark 71 programmed in the programmable identification element 50 includes a variety of unique printing features consisting of printing line structure, raised ink, pattern structure, printing color, fiber property, fiber component and fiber density etc.

Referring again to FIGS. 4 and 5, the programmable identification element 50 controlled by the controller 40 may finally output the identified result of the security mark 71 of the sample pattern 70 to the display unit 60.

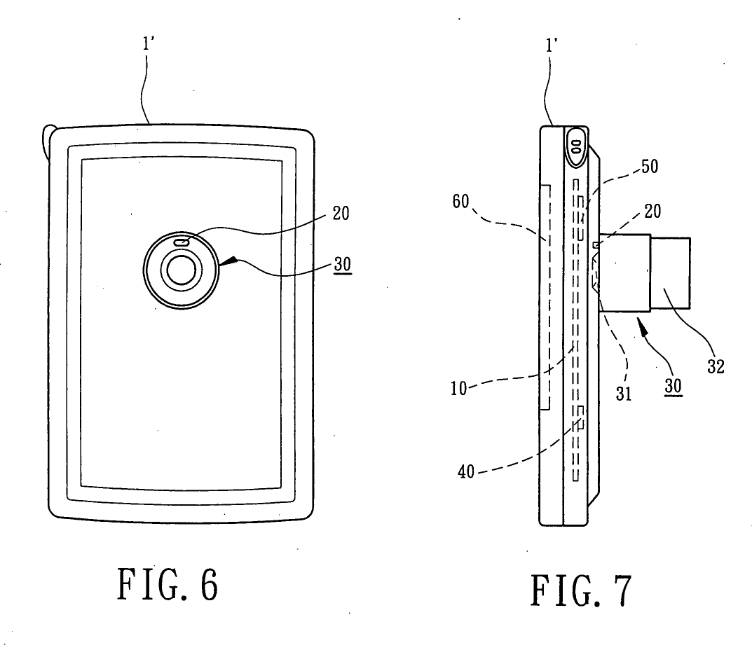

Turning now to FIGS. 6 and 7, reference numerals of the second embodiment of the present invention has applied the identical numerals of the first embodiment, as shown in FIGS. 1 through 4. The portable electronic device having the pattern identification system in accordance with the second embodiment of the present invention has similar configuration and same function as that of the first embodiment and the detailed descriptions may be omitted.

Referring to FIGS. 6 and 7, in comparison with the illustrated first embodiment, the portable electronic device of the second embodiment is a personal digital assistant (PDA) 1′. The personal digital assistant 1′ includes a substrate 10, an illumination device 20, a video camera unit 30, a controller 40, a programmable identification element 50 and a display unit 60. The substrate 10 is suitable for communication appliances such as personal digital assistants which provide with a fundamental function for communication. The substrate 10 is electrically connected to the illumination device 20, the video camera unit 30, the controller 40, the programmable identification element 50 and the display unit 60 so that the personal digital assistant 1′ is capable of operating counterfeit detection.

Still referring to FIGS. 6 and 7, in the second embodiment, the video camera unit 30 includes a camera device 31 and a telescopic, fixing device 32. Preferably, the camera device 31 includes a magnifying camera lens having a predetermined magnification rate which is adapted to magnify the sample pattern with a predetermined magnification rate. The camera device 31 then captures a reflecting image of the sample pattern. The telescopic, fixing device 32 is extendable and mounted on a periphery of the camera device so as to adjust and fix a relative distance between the camera device 31 and the sample pattern. In addition, the telescopic, fixing device 32 can prevent the sample pattern from interfering with external light. Preferably, the telescopic, fixing device 32 can be a retractable device which can be retracted into a casing of the personal digital assistant 1′. Alternatively, the telescopic, fixing device 32 can be a detachable tube which can be detached from the casing of the personal digital assistant 1′. After identifying, the telescopic, fixing device 32 can be retracted into or detached from the casing of the personal digital assistant 1′ which can return to permit processing digital information.

Referring back to FIGS. 5 and 7, in identifying operation, the portable electronic device (i.e. personal digital assistant 1′) of the second embodiment is initially aligned with the security mark 71 of the sample pattern 70, and may projects a predetermined wavelength of light on the security mark 71 from the illumination device 20. The camera device 31 of the video camera unit 30 can subsequently magnify an image of the sample pattern 70 with a predetermined magnifying times sufficient for identification, and capture an image of the sample pattern 70. The controller 40 subsequently connects to the programmable identification element 50 and sends the identifiable image thereto for identifying the sample pattern 70. The programmable identification element 50 may finally output the identified result of the sample pattern 70 to the display unit 60 of the personal digital assistant 1′.

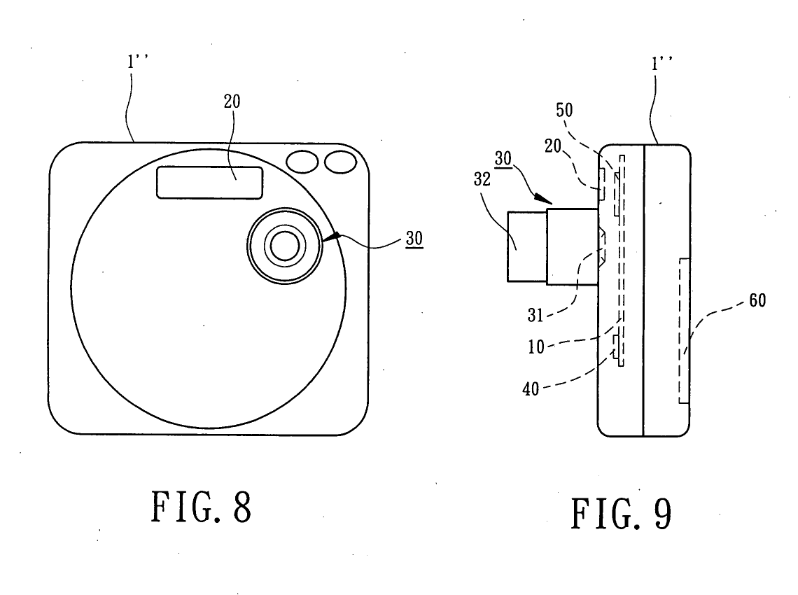

Turning now to FIGS. 8 and 9, reference numerals of the third embodiment of the present invention have applied the identical numerals of the first embodiment, as shown in FIGS. 1 through 4. The portable electronic device having the pattern identification system in accordance with the third embodiment of the present invention have similar configuration and same function as that of the first embodiment and the detailed descriptions may be omitted.

Referring to FIGS. 8 and 9, in comparison with the illustrated first embodiment, the portable electronic device of the third embodiment is a digital camera 1″. The digital camera 1″ includes a substrate 10, an illumination device 20, a video camera unit 30, a controller 40, a programmable identification element 50 and a display unit 60. The substrate 10 is suitable for photo appliances such as digital cameras which provide with a fundamental function for capturing image. The substrate 10 is electrically connected to the illumination device 20, the video camera unit 30, the controller 40, the programmable identification element 50 and the display unit 60 so that the digital camera 1″ is capable of operating counterfeit detection.

Still referring to FIGS. 8 and 9, in the third embodiment, the video camera unit 30 includes a camera device 31 and a telescopic, fixing device 32. Preferably, the camera device 31 includes a magnifying camera lens having a predetermined magnification rate/which is adapted to magnify the sample pattern with a predetermined magnification rate. The camera device 31 then captures a reflecting image of the sample pattern. The telescopic, fixing device 32 is extendable and mounted on a periphery of the camera device so as to adjust and fix a relative distance between the camera device 31 and the sample pattern. In addition, the telescopic, fixing device 32 can prevent the sample pattern from interfering with external light. Preferably, the telescopic, fixing device 32 can be a retractable device which can be retracted into a casing of the digital camera 1″. Alternatively, the telescopic, fixing device 32 can be a detachable tube which can be detached from the casing of the digital camera 1″. After identifying, the telescopic, fixing device 32 can be retracted into or detached from the casing of the digital camera 1″ which can return to permit capturing photographs.

Referring back to FIGS. 5 and 9, in identifying operation, the portable electronic device (i.e. digital camera 1″) in accordance with the present invention is initially aligned with the security mark 71 of the sample pattern 70, and may project a predetermined wavelength of light on the security mark 71 from the illumination device 20. The camera device 31 of the video camera unit 30 can subsequently magnify an image of the sample pattern 70 with a predetermined magnifying times sufficient for identification, and capture an image of the sample pattern 70. The controller 40 subsequently connects to the programmable identification element 50 and sends the identifiable image thereto for identifying the sample pattern 70. The programmable identification element 50 may finally output the identified result of the sample pattern 70 to the display unit 60 of the digital camera 1″.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A portable electronic device having a pattern identification system, comprising:
a substrate arranged in the portable electronic device;
an illumination device electronically connected to the substrate, and used to project a predetermined wavelength of light-on a sample pattern;
a video camera unit used to magnify an image of the sample pattern with a predetermined magnifying times to obtain an identifiable image of difference sufficient for identification;
a controller electronically connected to the substrate, and further electronically connected to the illumination device and the video camera unit for capturing the identifiable image of the sample pattern; and
a programmable identification element electronically connected to the substrate, and further electronically connected to the controller and the video camera unit, the programmable identification element including a recognizing logic for processing the identifiable image so as to generate a difference between the identifiable image and the recognizing logic, and the programmable identification element used to identify the identifiable image outputted from the video camera unit;
wherein the controller controls the video camera unit to output the identifiable image to the programmable identification element for identification.

2. The portable electronic device having the pattern identification system as defined in claim 1, further comprising a display unit used to display an identified result outputted from the programmable identification element.

3. The portable electronic device having the pattern identification system as defined in claim 1, wherein the illumination device projects a predetermined wavelength and brightness of light according to various types of the sample pattern.

4. The portable electronic device having the pattern identification system as defined in claim 1, wherein the video camera unit includes a camera device and a telescopic device which can be adjusted to a relative distance between the camera device and the sample pattern.

5. The portable electronic device having the pattern identification system as defined in claim 4, wherein the telescopic device includes a detachable tube which can be retracted into or detached from a casing of the portable electronic device.

6. The portable electronic device having the pattern identification system as defined in claim 1, wherein the video camera unit includes a camera device and a fixing device which can fix a relative distance between the camera device and the sample pattern.

7. The portable electronic device having the pattern identification system as defined in claim 6, wherein the fixing device includes a detachable tube which can be retracted into or detached from a casing of the portable electronic device.

8. The portable electronic device having the pattern identification system as defined in claim 1, wherein the programmable identification element is selected from a group consisting of an identification logical circuit and an identification IC programmed by a computer software.

9. The portable electronic device having the pattern identification system as defined in claim 1, wherein the programmable identification element is able to identify one or more of features consisting of printing line structure, raised ink, pattern structure, printing color, fiber property, fiber component and fiber density.

10. The portable electronic device having the pattern identification system as defined in claim 1, wherein the portable electronic device is applied to the sample pattern which includes a security mark printed or adhered on a wrapping paper or a package.

11. The portable electronic device having the pattern identification system as defined in claim 1, further comprising a socket for changing the programmable identification element.

12. The portable electronic device having the pattern identification system as defined in claim 1, wherein the portable electronic device is selected from a group consisting of a cellular phone, a beeper, a personal digital assistant, an electronic translator and a digital camera etc.
